(19) United States
(12) Patent Application Publication
(10) Pub. No.: US 2016/0303953 A1
(43) Pub. Date: Oct. 20, 2016

(54) VEHICLE DOOR

(71) Applicant: HONDA MOTOR CO., LTD., Tokyo (JP)

(72) Inventor: Takashi Fukahori, Wako-shi (JP)

(73) Assignee: HONDA MOTOR CO., LTD., Tokyo (JP)

(21) Appl. No.: 15/130,570

(22) Filed: Apr. 15, 2016

(30) Foreign Application Priority Data
Apr. 17, 2015 (JP) 2015-085198

(51) Int. Cl. B60J 5/04

(52) U.S. Cl. CPC B60J 5/0443; B60J 5/0426; B60J 5/0431; B60J 5/0429; B60Y 2304/07

(57) ABSTRACT

A vehicle door includes an elongated outer panel reinforcement member that reinforces an outer panel and an elongated door beam that reinforces the vehicle door. A front end of the outer panel reinforcement member in its lengthwise direction and a front end of the door beam in its lengthwise direction are joined. A rear end of the outer panel reinforcement member in its lengthwise direction and a rear end of the door beam in its lengthwise direction are joined.

### CROSS REFERENCES TO RELATED APPLICATIONS

The present application claims priority under 35 U.S.C. §119 to Japanese Patent Application No. 2015-085198, filed Apr. 17, 2015, entitled “Vehicle Door.” The contents of this application are incorporated herein by reference in their entirety.

### BACKGROUND

1. Field

The present disclosure relates to a vehicle door that is provided on a vehicle body so that the door can be easily opened and closed and that is equipped with a door beam that reinforces a door body and a reinforcement member that reinforces an outer panel of the door.

2. Description of the Related Art

Vehicle doors equipped with an outer panel reinforcement member that reinforces an outer panel and a door beam that reinforces the door are known. The outer panel reinforcement member is adhered to a substantially central portion of the outer panel in an up-down direction, with a front end portion and a rear end portion of the reinforcement member attached to an inner panel. In this manner, the outer panel is reinforced by the outer panel reinforcement member.

On the other hand, the door beam is a member separate from the outer panel reinforcement member and is attached to a lower portion of the door by attaching a front end portion and a rear end portion of the door beam to the inner panel. In this manner, the door is reinforced by the door beam (see, for example, Japanese Patent No. 5380520).

In the vehicle door of Japanese Patent No. 5380520, the outer panel reinforcement member is provided separately from the door beam and is lower in stiffness than the door beam. This requires a contrivance that prevents the outer panel reinforcement member from being deformed by load input during an operation of attaching, for example, the door beam higher in stiffness than the outer panel reinforcement member.

Furthermore, in the vehicle door of Japanese Patent No. 5380520, the outer panel reinforcement member and the door beam are separately attached to the inner panel. Therefore, the number of man-hours required to attach the outer panel reinforcement member and the door beam is considerably large. In this respect, too, the vehicle door needs to be improved.

SUMMARY

The present disclosure describes a vehicle door that is capable of preventing an outer panel reinforcement member from being deformed during assembly of the door and that allows reduction of the man-hours required to attach the outer panel reinforcement member and a door beam.

According to an aspect of the present disclosure there is provided a vehicle door that is provided on a vehicle body so as to be openable and closable and that includes an inner panel disposed at a cabin side, an outer panel disposed at an extra-vehicular space side, an outer panel reinforcement member having an elongated shape, extending in a vehicle body front-rear direction and attached to the inner side of the out panel so as to reinforce the outer panel, and a door beam having an elongated shape, extending in the vehicle body front-rear direction and attached to the inner panel of the vehicle door so as to reinforce the vehicle door. One end (a first end) of the outer panel reinforcement member in a lengthwise direction of the outer panel reinforcement member and one end (a first end) of the door beam in a lengthwise direction of the door beam are joined. Another end (a second end) of the outer panel reinforcement member in the lengthwise direction and another end (a second end) of the door beam in the lengthwise direction are joined.

In this vehicle door, the one end of the outer panel reinforcement member is joined to the one end of the door beam in the lengthwise direction and the another end of the outer panel reinforcement member is joined to the another end of the door beam in the lengthwise direction. Therefore, the one end and the another end of the outer panel reinforcement member (i.e., the two opposite ends thereof) can be joined to the door beam.

Note that the door beam, intended to reinforce the vehicle door, is provided with higher stiffness than the outer panel reinforcement member. Therefore, the outer panel reinforcement member can be reinforced by the stiffer door beam. This will prevent the outer panel reinforcement member from deforming during the assembly of the vehicle door.

Furthermore, since the two opposite ends of the outer panel reinforcement member are joined to the door beam, the outer panel reinforcement member and the door beam can be attached collectively as a unit to the door. This will reduce the man-hours required to attach the outer panel reinforcement member and the door beam.

In the foregoing vehicle door, the one end of the outer panel reinforcement member and the one end of the door beam may be disposed apart from each other in an up-down direction.

In this construction, the one end of the outer panel reinforcement member and the one end of the door beam are disposed apart in the up-down direction and, at the same time, the one end of the outer panel reinforcement member and the one end of the door beam are joined.

Therefore, the outer panel reinforcement member and the door beam can be disposed in a substantially V-0shaped arrangement. This arrangement allows the outer panel reinforcement member and the door beam to reinforce an increased area in the vehicle door, so that the stiffness of the vehicle door against torsion can be enhanced.

This vehicle door may further include a one-end (a first end) reinforcement member joined to the inner panel and connecting the one end of the outer panel reinforcement member and the one end of the door beam, and an another-end (a second end) reinforcement member joined to the inner panel and connecting the another end of the outer panel reinforcement member and the another end of the door beam. The outer panel reinforcement member, the door beam, the one-end reinforcement member, and the another-end reinforcement member may be joined into an integral unit.

In this construction, the outer panel reinforcement member, the door beam, the one-end reinforcement member, and the another-end reinforcement member are joined into one integral structure (i.e., unified into a single unit). Therefore, a stiffness of the unified unit can be secured, so that deformation of the outer panel reinforcement member, the door beam, the one-end reinforcement member, or the another-end reinforcement member in the unit (i.e., the single unit) can be reduced.

Hence, at the time of attaching the unit to the vehicle door, deformation of the unit can be substantially prevented, so that the operation of attaching the unit can be easily carried out.

Furthermore, the outer panel reinforcement member, the door beam, the one-end reinforcement member, and the another-end reinforcement member can be attached collectively as a unit to the vehicle door. This will reduce the man-hours required to attach the outer panel reinforcement member, the door beam, etc. to the vehicle door.

The vehicle door may further include a first connection portion and a second connection portion that are to be connected to the vehicle body so that the connecting portions support the vehicle door to be movable with respect to the vehicle door opening. Furthermore, the one end of the outer panel reinforcement member may be provided at substantially the same height as the first connection portion, and the one end of the door beam may be provided substantially the same height as the second connection portion.

In this construction, when the first connection portion and the second connection portion are connected to the vehicle body, the weight of the vehicle door acts on the first connection portion and the second connection portion. That is, in the vehicle door, particularly the first connection portion and the second connection portion receive load.

Therefore, the first connection portion is reinforced by disposing the one end of the outer panel reinforcement member at substantially the same height as the first connection portion. The second connection portion is also reinforced by disposing the one end of the door beam at substantially the same height as the second connection portion. Furthermore, the first connection portion and the second connection portion are provided vertically apart from each other.

Therefore, the first connection portion and the second connection portion vertically apart from each other can support weight of the vehicle door in a good manner. This enhances the attachment stability of the vehicle door to the vehicle body.

In the foregoing vehicle door, the first connection portion and the second connection portion may be disposed above and below one of the one end of the outer panel reinforcement member and the one end of the door beam and may be joined to the inner panel.

If, in a construction in which the first connection portion and the second connection portion are both joined to a portion of the inner panel which is above the outer panel reinforcement member, a load acts on the portion of the inner panel above the outer panel reinforcement member, it is then conceivable that both the first connection portion and the second connection portion will follow deformation of the inner panel and will deform (or be displaced).

Alternatively, if, in a construction in which the first connection portion and the second connection portion are both joined to a portion of the inner panel which is below the door beam, a load acts on the portion of the inner panel below the door beam, it is then conceivable that both the first connection portion and the second connection portion will follow deformation of the inner panel and will deform (or be displaced).

Thus, in the foregoing two cases, there is a possibility that both the first connection portion and the second connection portion will be deformed (or displaced) and therefore the position of the vehicle door relative to the vehicle body will shift.

Therefore, in the foregoing construction according to the present disclosure, the first connection portion and the second connection portion are joined to a portion of the inner panel above and a portion of the inner panel below, respectively, one of the one end of the outer panel reinforcement member and the one end of the door beam. Hence, in the case where a load acts on the portion of the inner panel above one of the outer panel reinforcement member and the door beam, the deformation (displacement) of the second connection portion occurring following deformation of the inner panel can be restrained or reduced.

On the other hand, in the case where a load acts on the portion of the inner panel below one of the outer panel reinforcement member and the door beam, the deformation (displacement) of the first connection portion occurring following deformation of the inner panel can be restrained or reduced.

Because deformation (or displacement) of one of the first connection portion and the second connection portion is restrained or reduced as described above, the positional shift of the vehicle door relative to the vehicle body can be reduced.

The vehicle door according to the present disclosure may further include a third connection portion provided at or near the another end of the outer panel reinforcement member which is to be connected to the vehicle body, and the outer panel reinforcement member and the door beam may be disposed only above or only below a straight line that connects the first connection portion and the third connection portion.

If a load is input to the vehicle door from the cabin side when the first connection portion and the third connection portion has been connected to the vehicle body, it is preferable that a portion along the straight line connecting the first connection portion and the third connection portion deform and bend. By causing the portion along the straight line to deform, it becomes possible to prevent the entire vehicle door from being pushed out to the extra-vehicular space side.

For example, if the outer panel reinforcement member and the door beam are provided astride the portion along the straight line connecting the first connection portion and the third connection portion, the stiffness of the portion along the straight line is enhanced. Therefore, when a load is input to the vehicle door from the cabin side, there is risk that the input load may push the front end of the vehicle door out to the extra-vehicular space side.

Therefore, in the foregoing vehicle body according to the present disclosure, the third connection portion is provided at or near the another end of the outer panel reinforcement member, and is connectable to the vehicle body. Furthermore, the outer panel reinforcement member and the door beam are disposed only above or only below the straight line that connects the first connection portion and the third connection portion.

Therefore, the stiffness of the portion along the straight line connecting the first connection portion and the third connection portion can be suitably reduced or restrained.

Hence, if a load is input to the vehicle door from the cabin side, the portion along the straight line connecting the first connection portion and the third connection portion will be deformed and bent. Because the portion along the straight line deforms in this manner, it is possible to prevent an event in which load input to the vehicle door from the cabin side pushes the entire vehicle door out to the extra-vehicular space side.

### BRIEF DESCRIPTION OF THE DRAWINGS

FIG. 1 is a side view showing a vehicle that includes a vehicle door according to the present disclosure.

FIG. 2 is a side view showing a state in which an outer panel has been detached from the vehicle door shown in FIG. 1.

FIG. 3 is a side view of an inner panel shown in FIG. 2 viewed from a cabin side.

FIG. 4 is an enlarged side view of portions of the inner panel shown in FIG. 2.

FIG. 5 is a side view showing a state in which a reinforcement unit has been detached from the inner panel shown in FIG. 4.

FIG. 6 is a side view of the reinforcement unit shown in FIG. 5.

FIG. 7 is a sectional view taken on line VII-VII in FIG. 1.

FIGS. 8A and 8B illustrate an example case where a vehicle door according to the present disclosure is prevented from being entirely pushed out to the extra-vehicular space side by load input to the vehicle door.

### DESCRIPTION OF THE PREFERRED EMBODIMENTS

Preferred embodiments of the present disclosure will be described hereinafter with reference to the accompanying drawings. Note that the terms “front (Fr)”, “rear (Rr)”, “left (L)”, and “right (R)” are based on the directions from the driver's seated position.

### Embodiments

A vehicle door 20 according to an embodiment of the disclosure will be described.

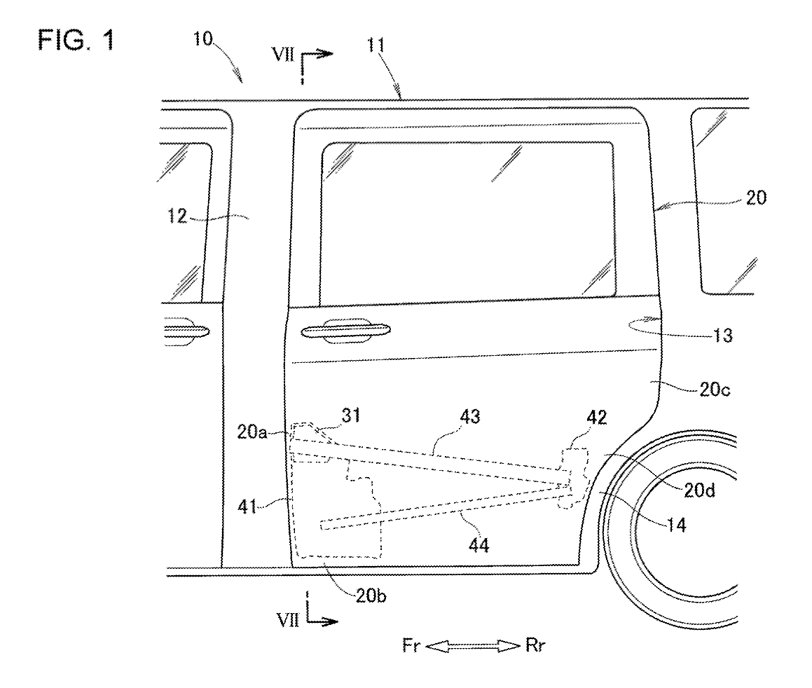

As shown in FIG. 1, a vehicle 10 includes a door opening portion 13 provided in a side portion 12 of a vehicle body 11 and a vehicle door 20 supported by the door opening portion 13 so that the vehicle door 20 can be easily opened and closed.

The door opening portion 13 is opened and closed by sliding the vehicle door 20 in the vehicle body front-rear direction. That is, the vehicle door 20 is a sliding door.

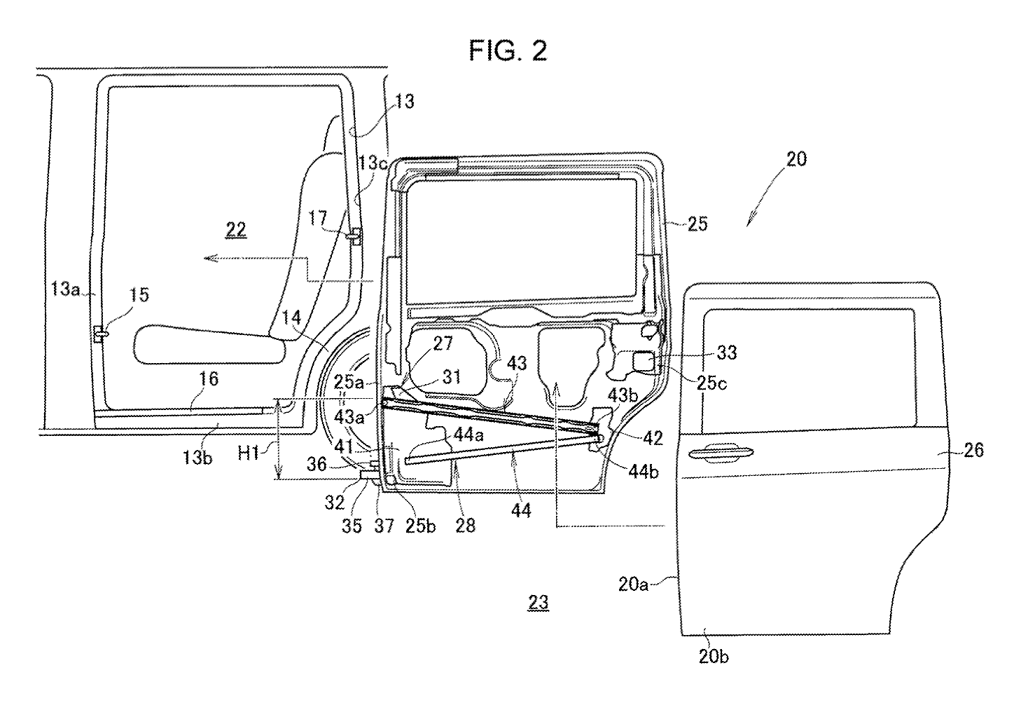

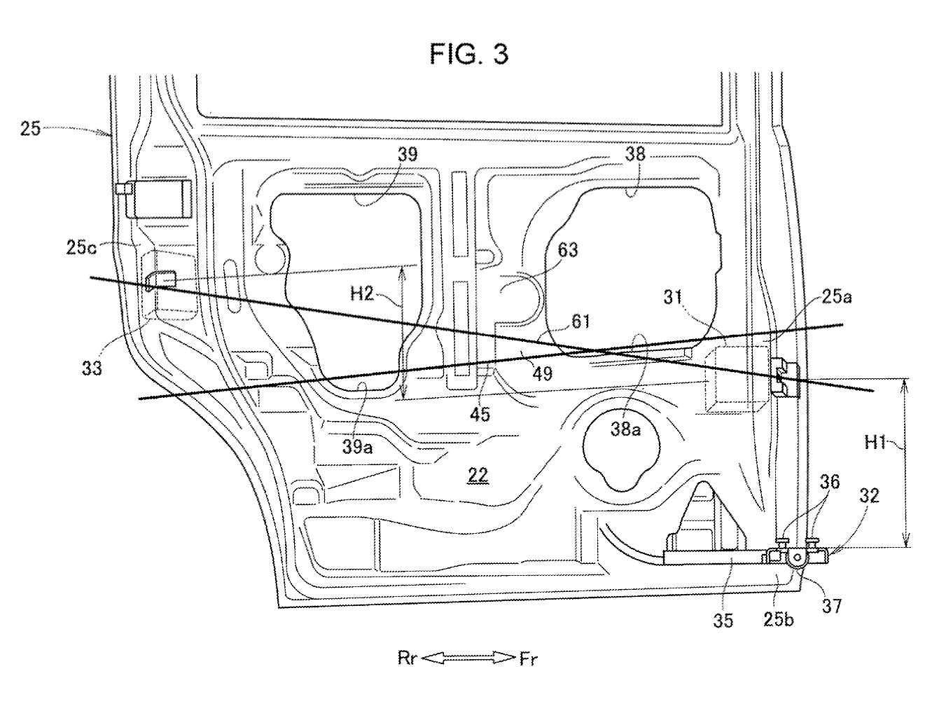

As shown in FIGS. 2 and 3, a front edge 13a of the door opening portion 13 is provided with a front striker 15. The front striker 15 is protruded rearward relative to the vehicle body 11 from the front edge 13a of the door opening portion 13. Furthermore, a lower edge 13b of the door opening portion 13 is provided with a lower slide rail 16. The lower slide rail 16 is provided in the vehicle body front-rear direction on the lower edge 13b of the door opening portion 13.

Furthermore, a rear edge 13c of the door opening portion 13 is provided with a rear striker 17. The rear striker 17 is protruded forward relative to the vehicle body 11 from the rear edge 13c of the door opening portion 13.

The vehicle door 20 includes an inner panel 25 disposed at a cabin 22 side, an outer panel 26 disposed at an extra-vehicular space 23 side, a connection unit 27 that connects to the vehicle body 11, and a reinforcement unit (integral unit) 28 interposed between the outer panel 26 and the inner panel 25.

The inner panel 25 is provided with a front opening portion 38 and a rear opening portion 39. Furthermore, a front latch apparatus 31 of the connection unit 27 is provided in a lower front-side vicinity of the lower edge 38a of the front opening portion 38. Further, a lower edge 39a of the rear opening portion 39 is provided on an imaginary extension line from the lower edge 38a of the front opening portion 38 and the connection unit 27.

Therefore, at a site along a straight line 45 connecting the front latch apparatus 31, the lower edge 38a of the front opening portion 38, and the lower edge 39a of the rear opening portion 39 there is formed a fragile portion 49 of the inner panel 25. The fragile portion 49 is a fragile portion of the vehicle door 20.

A reason why the vehicle door 20 is provided with the fragile portion 49 will be described later.

The connection unit 27 includes the front latch apparatus (first connection portion) 31 provided in a relatively lower front portion 25a of the inner panel 25, a slide device (second connection portion) 32 provided in a lower front portion 25b of the inner panel 25, and a rear latch apparatus (third connection portion) 33 provided in a rear central portion 25c of the inner panel 25.

The relatively lower front portion 25a is a portion at a front end of the inner panel 25 which is relatively close to the lower front portion 25b. The rear central portion 25c is a portion at a rear end of the inner panel 25 and relatively close to a center of the inner panel 25 in the up-down direction.

The front latch apparatus 31 is attached to the relatively lower front portion 25a of the inner panel 25. The front latch apparatus 31 latches with the front striker 15 when the vehicle door 20 is closed.

By the front latch apparatus 31 latching with the front striker 15, the relatively lower front portion 20a (see also FIG. 1) of the vehicle door 20 is connected to the front edge 13a of the door opening portion 13 (i.e., the side portion 12 of the vehicle body 11). The front latch apparatus 31 and the front striker 15 are configured in substantially the same manner as a latch apparatus and a striker that are used in an ordinary vehicle.

Furthermore, the slide device 32 is attached to the lower front portion 25b of the inner panel 25. The slide device 32 includes a lower guide 35 attached to the lower front portion 25b of the inner panel 25 and includes horizontal rollers 36 and a vertical roller 37 that are freely rotatably provided on a distal end of the lower guide 35.

The horizontal rollers 36 and the vertical roller 37 are freely movably supported on the lower slide rail 16. The lower slide rail 16 provided on the lower edge 13b of the door opening portion 13 and extends in the vehicle body front-rear direction.

Thus, as the slide device 32 is supported on the lower slide rail 16, the lower front portion 20b of the vehicle door 20 (see also FIG. 1) is connected to the lower edge 13b of the door opening portion 13 (i.e., to the side portion 12 of the vehicle body 11).

The horizontal rollers 36 and the vertical roller 37 are freely movably supported on the lower slide rail 16. Therefore, when the vehicle door 20 is opened and closed, the horizontal rollers 36 and the vertical roller 37 move in the vehicle body front-rear direction along the lower slide rail 16.

The slide device 32 is attached to the lower front portion 25b of the inner panel 25 and the front latch apparatus 31 is attached to the relatively lower front portion 25a of the inner panel 25. Therefore, the front latch apparatus 31 is provided a distance H1 above the slide device 32.

The slide device 32 and the lower slide rail 16 are configured in substantially the same manner as a slide device and a lower slide rail that are used in an ordinary vehicle.

Furthermore, the rear latch apparatus 33 is attached to the rear central portion 25c of the inner panel 25. The rear latch apparatus 33 latches with the rear striker 17 when the vehicle door 20 is closed.

As the rear latch apparatus 33 latches with the rear striker 17, the rear end 20c of the vehicle door 20 (see FIG. 1) is connected to the rear edge 13c of the door opening portion 13 (i.e., to the side portion 12 of the vehicle body 11). The rear latch apparatus 33 and the rear striker 17 are configured in substantially the same manner as a latch apparatus and a striker that are used in an ordinary vehicle.

Because the rear latch apparatus 33 is attached to the rear central portion 25c of the inner panel 25, the rear latch apparatus 33 is provided a distance H2 above the front latch apparatus 31.

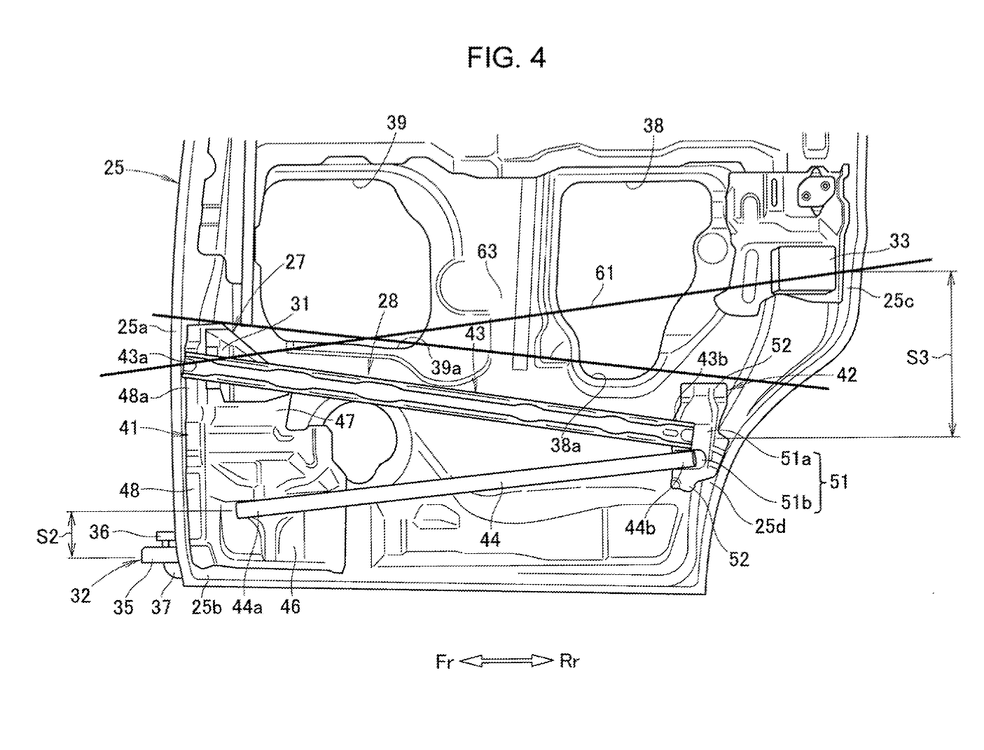

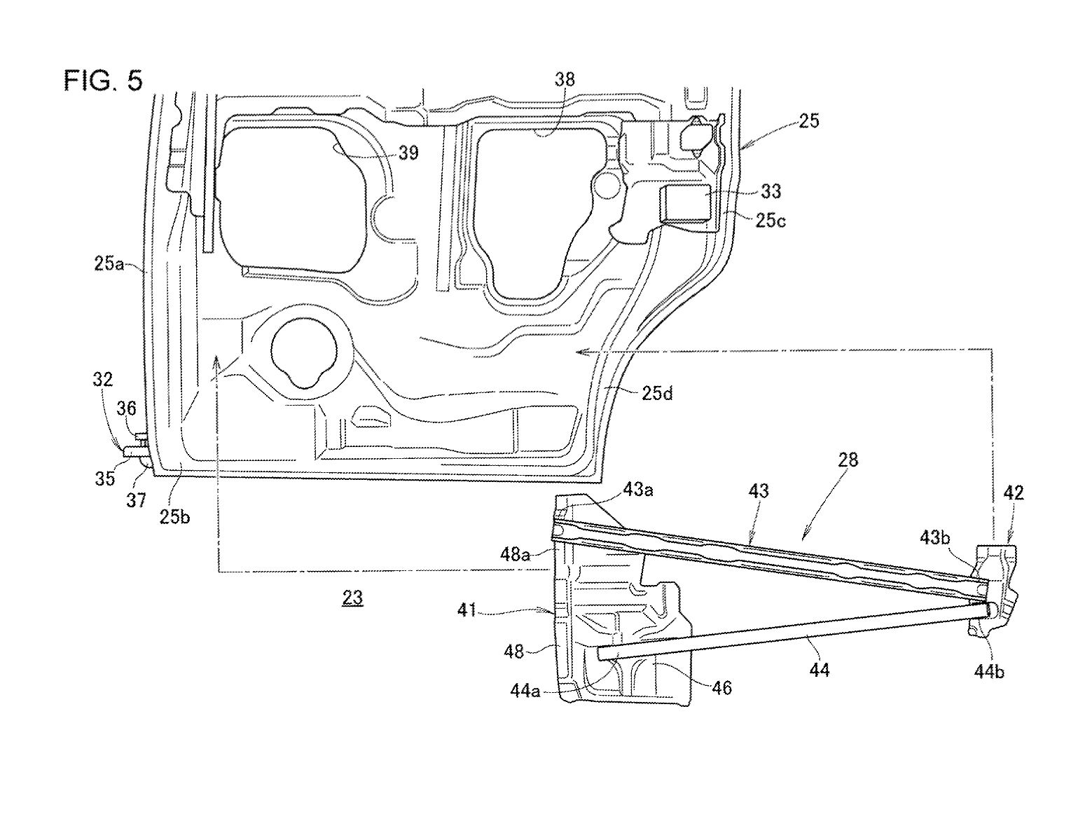

As shown in FIGS. 4 and 5, the reinforcement unit 28 includes a front bracket (one-end reinforcement member) 41 joined to the relatively lower front portion 25a and the lower front portion 25b of the inner panel 25, a rear bracket (another-end reinforcement member) 42 joined to the lower rear portion 25d of the inner panel 25, an outer panel reinforcement member 43 connected to and extending between the front bracket 41 and the rear bracket 42, and a door beam 44 disposed below the outer panel reinforcement member 43.

The front bracket 41, the rear bracket 42, the outer panel reinforcement member 43, and the door beam 44 are integrally joined. Because the front bracket 41, the rear bracket 42, the outer panel reinforcement member 43, and the door beam 44 are integrally joined, a substantially triangular reinforcement unit 28 is formed (i.e., a unified single unit is formed), so that a stiffness of the reinforcement unit 28 is secured.

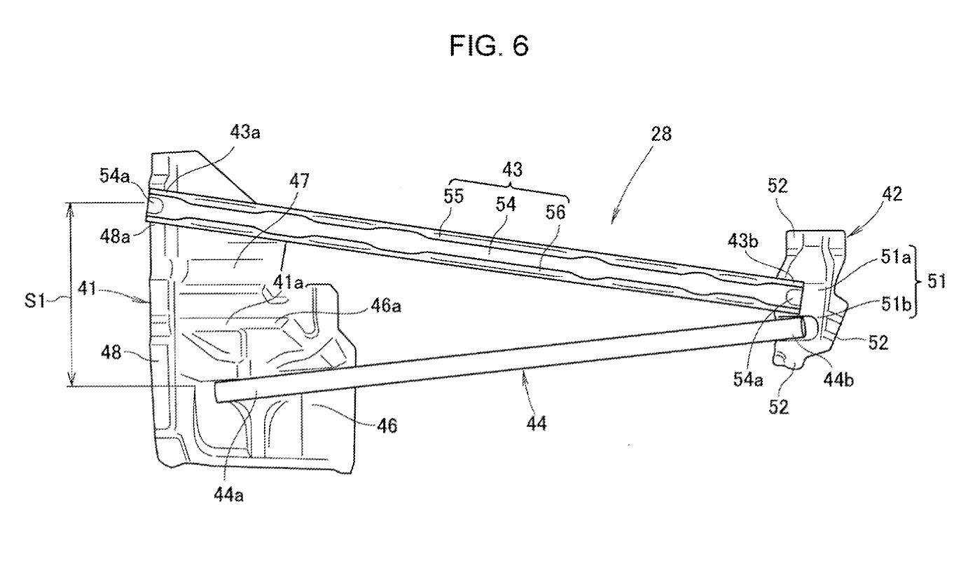

As shown in FIG. 6, the front bracket 41 includes a side wall 46 that forms a lower half portion of the front bracket 41, a housing depression portion 47 connected to the upper end 46a of the side wall 46, and a front projected piece 48 that is formed on the front ends of the side wall 46 and the housing depression portion 47.

The housing depression portion 47 is formed in a shape depressed toward the cabin 22 (see FIG. 2). The front latch apparatus 31 is housed in the housing depression portion 47 (see FIG. 4).

Because the front bracket 41 is joined to the relatively lower front portion 25a and to a lower front portion 25b (see FIG. 4) of the inner panel 25, the relatively lower front portion 25a and the lower front portion 25b of the inner panel 25 are reinforced by the front bracket 41.

The rear bracket 42 includes a central portion 51 that has a substantially quadrangular shape when viewed sideways and that is raised to the extra-vehicular space 23 side and joint portions 52 provided around the central portion 51 (more concretely, provided on upper, lower and rear portions thereof).

Because the joint portion 52 of the rear bracket 42 is joined to the lower rear portion 25d (see FIG. 4) of the inner panel 25, the lower rear portion 25d of the inner panel 25 is reinforced by the rear bracket 42. In this state, the rear bracket 42 is disposed at substantially the same height as a central portion 41a of the front bracket 41 in the up-down direction.

The outer panel reinforcement member 43 is connected to and extends between the front bracket 41 and the rear bracket 42. Therefore, the outer panel reinforcement member 43 has an elongated shape that extends in the vehicle body front-rear direction.

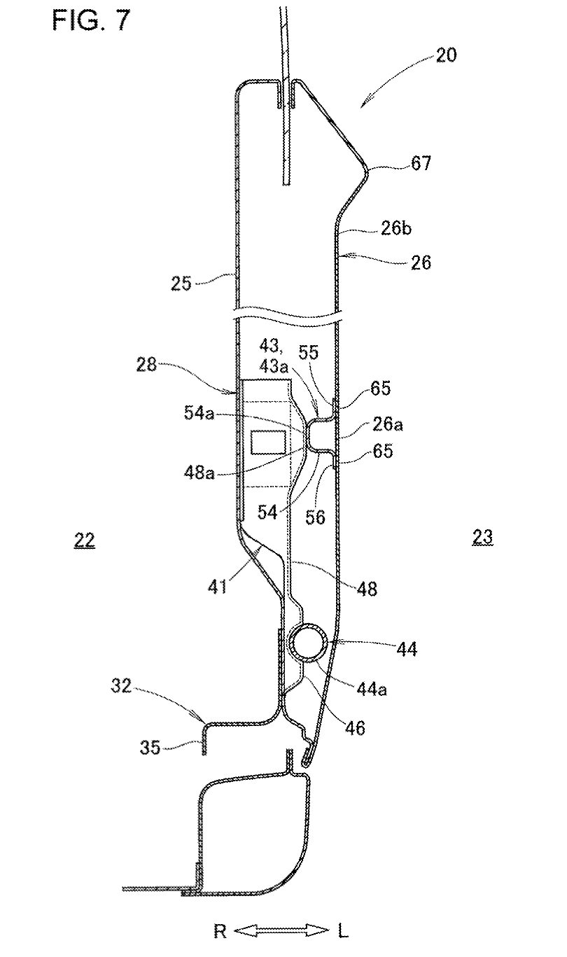

As shown in FIGS. 6 and 7, the outer panel reinforcement member 43 includes a U-sectional shaped portion 54 having a substantially U shape in section, an upper flange 55 projected upward from an upper end portion of the U-sectional shaped portion 54, and a lower flange 56 projected downward from a lower end portion of the U-sectional shaped portion 54.

The outer panel reinforcement member 43 is formed by the U-sectional shaped portion 54, the upper flange 55, and the lower flange 56 so as to have a substantially hat shape in section. In a front end (one end) 43a of the outer panel reinforcement member 43 in a lengthwise direction thereof, a top portion 54a of the U-sectional shaped portion 54 is joined to an upper end 48a of the front bracket 41 (concretely, of the front projected piece 48) from the extra-vehicular space 23 side.

In a rear end (another end) 43b of the outer panel reinforcement member 43 in the lengthwise direction, the top portion 54a of the U-sectional shaped portion 54 is joined to an upper portion 51a of the rear bracket 42 (concretely, of the central portion 51) from the extra-vehicular space 23 side.

That is, the outer panel reinforcement member 43 is connected to and extends between the upper end 48a of the front projected piece 48 and the upper portion 51a of the central portion 51. In this state, the outer panel reinforcement member 43 extends with a descending gradient rearward relative to the vehicle body 11.

The door beam 44 is disposed below the outer panel reinforcement member 43.

The door beam 44 is a hollow cylindrical member having a hollow elongated shape that extends in the vehicle body front-rear direction. Because the door beam 44 has a hollow cylindrical shape, the stiffness of the door beam 44 is set higher than that of the outer panel reinforcement member 43.

A front end (one end) 44a of the door beam 44 in the lengthwise direction is joined to the side wall 46 of the front bracket 41 from the extra-vehicular space 23 side. Furthermore, a rear end (another end) 44b of the door beam 44 in the lengthwise direction is joined to a lower portion 51b of the rear bracket 42 (concretely, of the central portion 51) from the extra-vehicular space 23 side.

That is, the door beam 44 is connected to and extends between the side wall 46 of the front bracket 41 and the lower portion 51b of the central portion 51. In this state, the door beam 44 extends rearward relative to the vehicle body 11, with an ascending gradient.

Thus, the front end 43a of the outer panel reinforcement member 43 and the front end 44a of the door beam 44 are joined via the front bracket 41. In this state, the front end 43a of the outer panel reinforcement member 43 and the front end 44a of the door beam 44 are apart from each other by a distance S1 in the up-down direction.

In other words, the front end 43a of the outer panel reinforcement member 43 is disposed the distance S1 above the front end 44a of the door beam 44.

Furthermore, the rear end 43b of the outer panel reinforcement member 43 and the rear end 44b of the door beam 44 are joined via the rear bracket 42 so as to be adjacent to each other in the up-down direction.

Thus, the outer panel reinforcement member 43 and the door beam 44 form a substantially V shape. Furthermore, the front bracket 41, the rear bracket 42, the outer panel reinforcement member 43 and the door beam 44 integrally form the substantially triangular reinforcement unit 28 (i.e., the reinforcement unit 28 is unified into a single unit).

The substantially triangular reinforcement unit 28 made up of the front bracket 41, the rear bracket 42, the outer panel reinforcement member 43, and the door beam 44 is attached to the vehicle door 20 (see FIG. 2).

Concretely, as shown in FIGS. 4 and 5, the front bracket 41, with the front end 43a of the outer panel reinforcement member 43 and the front end 44a of the door beam 44 connected to the front bracket 41, is joined to the relatively lower front portion 25a and the lower front portion 25b of the inner panel 25 from the extra-vehicular space 23 side.

Furthermore, the rear bracket 42, with the rear end 43b of the outer panel reinforcement member 43 and the rear end 44b of the door beam 44 connected to the rear bracket 42, is joined to the lower rear portion 25d of the inner panel 25 from the extra-vehicular space 23 side. Therefore, the reinforcement unit 28 is attached to the inner panel 25.

Note that the stiffness of the door beam 44 is higher than that of the outer panel reinforcement member 43. Therefore, as the front bracket 41, the rear bracket 42, the outer panel reinforcement member 43, and the door beam 44 form the substantially triangular reinforcement unit 28, the outer panel reinforcement member 43 can be reinforced by the high-stiffness door beam 44.

This will prevent the outer panel reinforcement member 43 from being deformed at the time of assembling the vehicle door 20.

Furthermore, because the front bracket 41, the rear bracket 42, the outer panel reinforcement member 43, and the door beam 44 form the substantially triangular reinforcement unit 28, the reinforcement unit 28 is unified into a single unit. Therefore, a stiffness of the reinforcement unit 28 is secured, so that deformation of the reinforcement unit 28 in a unit state (i.e., a single unit state) is restrained.

This restrains deformation of the reinforcement unit 28 when the front bracket 41 and the rear bracket 42 of the reinforcement unit 28 are attached to the inner panel 25, so that the operation of attaching the reinforcement unit 28 can be more easily performed.

Furthermore, the front bracket 41, the rear bracket 42, the outer panel reinforcement member 43, and the door beam 44 can be attached collectively as the reinforcement unit 28 to the vehicle door 20.

In other words, because the outer panel reinforcement member 43 is joined to the door beam 44, the outer panel reinforcement member 43 and the door beam 44 can be collectively attached to the vehicle door 20.

Therefore, the man-hours required for this attaching operation can be made less than the man-hours required to individually attach the outer panel reinforcement member 43 and the door beam 44 to the vehicle door 20.

As the reinforcement unit 28 is attached to the inner panel 25, the door beam 44 is connected to and extends between the lower front portion 25b and the lower rear portion 25d of the inner panel 25. Therefore, the door beam 44 extends in the vehicle body front-rear direction and reinforces the vehicle door 20 (see FIG. 2).

Furthermore, the outer panel reinforcement member 43 and the door beam 44 are connected so as to form a substantially V shape. Hence, when the reinforcement unit 28 is attached to the inner panel 25, the outer panel reinforcement member 43 and the door beam 44 can reinforce a large area in the vehicle door 20.

This increases the stiffness of the vehicle door 20 against torsional force input to the vehicle door 20, so that deformation of the vehicle door 20 can be restrained.

When the reinforcement unit 28 has been attached to the inner panel 25, the front end 43a of the outer panel reinforcement member 43 is at substantially the same height as the front latch apparatus 31.

Furthermore, the front end 44a of the door beam 44 is provided at substantially the same height as the slide device 32. Concretely, the front end 44a of the door beam 44 is slightly higher by the distance S2 than the slide device 32.

Furthermore, the rear end 43b of the outer panel reinforcement member 43 is slightly lower by the distance S3 than the rear latch apparatus 33. In other words, the rear latch apparatus 33 is provided in a rear end 43b-side vicinity of the outer panel reinforcement member 43.

Furthermore, the lower rear portion 25d of the inner panel 25 forms an inner wall of a lower rear portion 20d (see FIG. 1) of the vehicle door 20.

As shown in FIG. 1, the lower rear portion 20d of the vehicle door 20 has a curved recess shape that corresponds to the shape of a wheel house 14 of the vehicle body 11. That is, the lower rear portion 20d has a curved shape that is depressed forward relative to the vehicle body 11.

Therefore, the distance between the lower rear portion 20d and the relatively lower front portion 20a of the vehicle door 20 can be relatively short. Besides, the distance between the lower rear portion 20d and the lower front portion 20b of the vehicle door 20 can be relatively short.

As shown in FIGS. 1 and 4, the relatively lower front portion 25a of the inner panel 25 is a portion that corresponds to the relatively lower front portion 20a of the vehicle door 20. Furthermore, the lower front portion 25b of the inner panel 25 is a portion that corresponds to the lower front portion 20b of the vehicle door 20. Still further, the lower rear portion 25d of the inner panel 25 is a portion that corresponds to the lower rear portion 20d of the vehicle door 20.

Therefore, the distance between the relatively lower front portion 25a of the inner panel 25 and the lower rear portion 25d of the inner panel 25 can be relatively short. Besides, the distance between the lower front portion 25b of the inner panel 25 and the lower rear portion 25d of the inner panel 25 can also be relatively short. Therefore, when the rear bracket 42 is joined to the lower rear portion 25d, the outer panel reinforcement member 43 is disposed between the relatively lower front portion 25a and the lower rear portion 25d, and the door beam 44 is disposed between the lower front portion 25b and the lower rear portion 25d.

Therefore, the outer panel reinforcement member 43 and the door beam 44 can be relatively short, so that the outer panel reinforcement member 43 and the door beam 44 (i.e., the vehicle door 20) can be reduced in weight.

Note that, as shown in FIG. 2, when the vehicle door 20 is closed (see FIG. 1), the front latch apparatus 31 is connected to the side portion 12 of the vehicle body 11 via the front striker 15, and the slide device 32 is connected to the side portion 12 of the vehicle body 11 via the lower slide rail 16.

When the front latch apparatus 31 and the slide device 32 are connected to the side portion 12 of the vehicle body 11, weight of the vehicle door 20 acts on the front latch apparatus 31 and the slide device 32. That is, in the vehicle door 20, particularly the front latch apparatus 31 and the slide device 32 receive load.

Therefore, the front end 43a of the outer panel reinforcement member 43 is provided at substantially the same height as the front latch apparatus 31, so that the front latch apparatus 31 is reinforced. Furthermore, the front end 44a of the door beam 44 is provided at substantially the same height as the slide device 32, so that the slide device 32 is reinforced.

Furthermore, the front latch apparatus 31 and the slide device 32 are provided apart from each other by the distance H1 in the up-down direction.

Therefore, the front latch apparatus 31 and the slide device 32, which are vertically apart from each other, can support the weight of the vehicle door 20 in a good manner. As a result, the attachment stability of the vehicle door 20 to the side portion 12 of the vehicle body 11 can be enhanced.

Furthermore, as shown in FIG. 4, the outer panel reinforcement member 43 and the door beam 44 are disposed only below a straight line 61 that connects the front latch apparatus 31 and the rear latch apparatus 33. By disposing the outer panel reinforcement member 43 and the door beam 44 apart downward from the straight line 61, the stiffness of an area 63 along the straight line 61 connecting the front latch apparatus 31 and the rear latch apparatus 33 can be suitably reduced.

Therefore, when a load orthogonal to the vehicle door 20 is input to the vehicle door 20, the area 63 along the straight line 61 can be deformed by the input load so as to bend. This will prevent the entire vehicle door 20 from being pushed out to the extra-vehicular space 23 side.

Furthermore, the front latch apparatus 31 is provided above the front end 44a of the door beam 44, and the slide device 32 is provided below the front end 44a of the door beam 44. That is, the front latch apparatus 31 and the slide device 32 are provided above and below, respectively, the front end 44a of the door beam 44.

Therefore, when a portion of the vehicle door 20 above the door beam 44 receives a load orthogonal to the vehicle door 20, an event in which the slide device 32, following the deformation of the inner panel 25, deforms (or is displaced) to the extra-vehicular space 23 side can be substantially prevented.

On the other hand, when a large force acts below the door beam 44, an event in which the front latch apparatus 31, following the deformation of the inner panel 25, deforms (or is displaced) to the extra-vehicular space 23 side can be substantially prevented.

Referring back to FIG. 7, when the reinforcement unit 28 is attached to the inner panel 25, the outer panel reinforcement member 43 extends in the vehicle body front-rear direction (see FIG. 4).

In this state, the upper flange 55 and the lower flange 56 of the outer panel reinforcement member 43 are adhered to a lower half portion 26a of the outer panel 26 by an adhesive 65. Therefore, the outer panel 26 (particularly, the lower half portion 26a) is reinforced by the outer panel reinforcement member 43, so that a stiffness of the outer panel 26 is secured.

The outer panel reinforcement member 43 is disposed below the straight line 61 (see FIG. 4) that connects the front latch apparatus 31 and the rear latch apparatus 33. Therefore, a designed surface of an upper half portion 26b the outer panel 26 which is above the outer panel reinforcement member 43 can be freely formed. Concretely, a bent portion 67 that extends in the vehicle body front-rear direction is formed in the upper half portion 26b of the outer panel 26.

The bent portion 67 is bent to have a substantially V-sectional shape that is protruded to the extra-vehicular space 23 side. Therefore, due to the designed surface of the upper half portion 26b of the outer panel 26, a stiffness of the outer panel 26 (particularly, the upper half portion 26b) is secured.

Furthermore, because a stiffness of the outer panel 26 is secured by utilizing the designed surface of the outer panel 26, the thickness of the outer panel 26 can be relatively small and the stiffness of the outer panel reinforcement member 43 can be relatively low, so that it is possible to reduce the weight of the vehicle door 20.

Thus, because the outer panel reinforcement member 43 is adhered to the lower half portion 26a of the outer panel 26 by adhesive and the upper half portion 26b of the outer panel 26 is provided with the bent portion 67, a stiffness of the outer panel 26 as a whole can be secured.

That is, since the upper half portion 26b of the outer panel 26 is reinforced by the bent portion 67, it is possible to adhere the outer panel reinforcement member 43 to the lower half portion 26a of the outer panel 26, so that the degree of freedom in design can be increased.

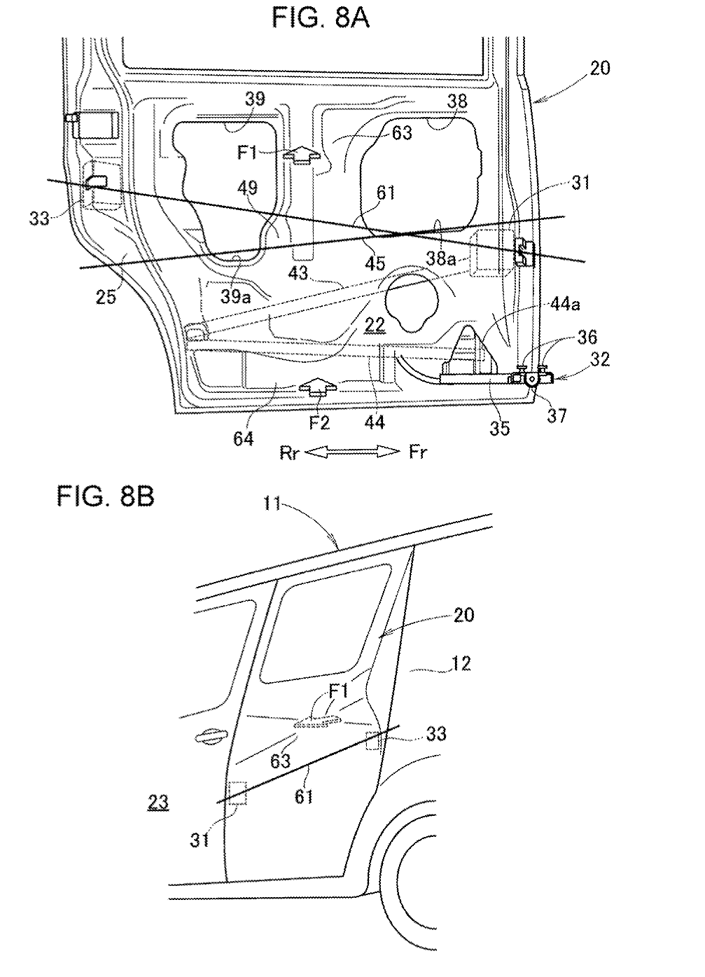

Next, an example in which when a load F1 is input to the vehicle door 20 from the cabin 22 side, an event in which the input load F1 pushes out the entire vehicle door 20 to the extra-vehicular space 23 side is prevented will be described with reference to FIGS. 8A and 8B.

As shown in FIG. 8A, the load F1 is input to the vehicle door 20 from the cabin 22 side.

Note that the outer panel reinforcement member 43 and the door beam 44 are disposed only below and apart from the straight line 61 connecting the front latch apparatus 31 and the rear latch apparatus 33.

Therefore, with the input load F1, the area 63 along the straight line 61 can be deformed to bend.

As shown in FIG. 8B, because the area 63 along the straight line 61 is deformed, the front latch apparatus 31, the rear latch apparatus 33, and the slide device 32 can be kept latched with the side portion 12 of the vehicle body 11.

Concretely, the front latch apparatus 31 is can be kept latched with the front striker 15. The rear latch apparatus 33 can be kept latched with the rear striker 17. Furthermore, the slide device 32 can be kept latched with the lower slide rail 16.

Therefore, the event in which the load F1 input from the cabin 22 side pushes out the entire vehicle door 20 to the extra-vehicular space 23 side can be prevented. Hence, the positional shift of the vehicle door 20 relative to the side portion 12 of the vehicle body 11 can be reduced.

Referring back to FIG. 8A, the front latch apparatus 31 is provided above the front end 44a of the door beam 44 and the slide device 32 is provided below the front end 44a of the door beam 44.

Therefore, when the load F1 is input above the door beam 44 (e.g., to the area 63 along the straight line 61), the event in which the slide device 32, following the deformation of the inner panel 25, deforms (or is displaced) to the extra-vehicular space 23 side can be substantially prevented by the door beam 44.

On the other hand, when a load F2 is input to a lower area 64 below the door beam 44, the event in which the front latch apparatus 31, following the deformation of the inner panel 25, deforms (or is displaced) to the extra-vehicular space 23 side can be substantially prevented by the door beam 44.

Thus, because deformation (displacement) of one of the front latch apparatus 31 and the slide device 32 to the extra-vehicular space 23 side is substantially prevented, the positional shift of the vehicle door 20 (see FIG. 8B) relative to the side portion 12 of the vehicle body 11 can be reduced.

Furthermore, in an area along the straight line 45 connecting the front latch apparatus 31, the lower edge 38a of the front opening portion 38, and the lower edge 39a of the rear opening portion 39, the fragile portion 49 of the vehicle door 20 is formed. Therefore, when the load F1 is input to the vehicle door 20, the vehicle door 20 can be suitably bent, with the fragile portion 49 being a bending start point.

Therefore, the positional shift of the vehicle door 20 relative to the side portion 12 of the vehicle body (see FIG. 8B) can be more favorably reduced.

Incidentally, the vehicle door according to the present disclosure is not limited to the foregoing embodiment or the like but can be changed or improved as appropriate.

For example, although in the foregoing embodiment, the outer panel reinforcement member 43 and the door beam 44 are provided only below the straight line 61 connecting the front latch apparatus 31 and the rear latch apparatus 33, this is not restrictive. The outer panel reinforcement member 43 and the door beam 44 may be provided only above the straight line 61.

In such a case, it is conceivable to provide the outer panel reinforcement member 43 and the door beam 44 in the upper half portion 26b of the outer panel 26. Therefore, it is preferable to form a bent portion 67 in the lower half portion 26a of the outer panel 26.

Furthermore, although in the foregoing embodiment, the front latch apparatus 31 is provided above the front end 44a of the door beam 44 and the slide device 32 is provided below the front end 44a of the door beam 44, this is not restrictive. The front latch apparatus 31 may be provided above the front end 43a of the outer panel reinforcement member 43 and the slide device 32 may be provided below the front end 43a of the outer panel reinforcement member 43.

Furthermore, the shapes and configurations of the components, structures, etc. mentioned above in conjunction with the embodiment, such as the vehicle, the vehicle body, the side portion of the vehicle body, the vehicle door, the inner panel, the outer panel, the reinforcement unit, the front latch apparatus, the slide device, the rear latch apparatus, the front bracket, the rear bracket, the outer panel reinforcement member, and the door beams, are not limited to what have been shown above as examples but may be changed or modified as appropriate.

The vehicle door of the present disclosure is suitably applicable to a motor vehicle whose vehicle body is provided with a vehicle door that can be easily opened and closed and that includes a door beam that reinforces a door body and a reinforcement member that reinforces the outer panel of the vehicle door.

What is claimed is:

1. A vehicle door provided to a vehicle body so as to be openable and closable, the vehicle door comprising:
an inner panel disposed at a vehicle interior side;
an outer panel disposed at a vehicle exterior side;
an outer panel reinforcement member having an elongated body with a first end and a second end, extending in a vehicle body front-rear direction, and attached to an inner side of the outer panel so as to reinforce the outer panel; and
a door beam having an elongated body with a first end and a second end and extending in the vehicle body front-rear direction, the first and second ends of the door beam being attached to the inner panel of the vehicle door so as to reinforce the vehicle door,
wherein the first end of the outer panel reinforcement member and the first end of the door beam are joined, and
wherein the second end of the outer panel reinforcement member and the second end of the door beam are joined.

2. The vehicle door according to claim 1, wherein the first end of the outer panel reinforcement member and the one first of the door beam are disposed apart from each other in an up-down direction.

3. The vehicle door according to claim 1, further comprising:
a first reinforcement member joined to the inner panel and connecting the first end of the outer panel reinforcement member and the first end of the door beam together, thereby joining their first ends; and
a second end reinforcement member joined to the inner panel and connecting the second end of the outer panel reinforcement member and the second end of the door beam together, thereby joining the second end of the outer panel reinforcement member and the second end of the door beam, such that the outer panel reinforcement member, the door beam, the first end reinforcement member, and the second end reinforcement member are joined into one integral structure.

4. The vehicle door according to claim 1, further comprising a first connection portion and a second connection portion that connects the vehicle door to the vehicle body,
wherein the first end of the outer panel reinforcement member is provided at substantially the same height as the first connection portion, and
wherein the first end of the door beam is provided substantially the same height as the second connection portion.

5. The vehicle door according to claim 4, wherein the first connection portion and the second connection portion are respectively disposed at an upper side and a lower side with respect to either of the first end of the outer panel reinforcement member or the first end of the door beam.

6. The vehicle door according to claim 4, further comprising a third connection portion that connects the vehicle door to the vehicle body and provided at or in a vicinity of the second end of the outer panel reinforcement member,
wherein both the outer panel reinforcement member and the door beam are disposed at either of an upper side or a lower side with respect to an imaginary straight line that connects the first connection portion and the third connection portion.
